(19) United States
(12) Patent Application Publication
(10) Pub. No.: US 2026/0211524 A1
(43) Pub. Date: Jul. 23, 2026

(54) INTERACTION METHOD BETWEEN EXTERNAL OBJECT AND TOUCH DISPLAY DEVICE, TOUCH PROCESSOR, TOUCH DISPLAY DEVICE AND TOUCH SYSTEM

(71) Applicant: BOE Technology Group Co., Ltd., Beijing (CN)

(72) Inventors: Zhaohui MENG, Beijing (CN); Xiaofeng YIN, Beijing (CN); Shengbao DUN, Beijing (CN); Yiguan WANG, Beijing (CN); Lin CONG, Beijing (CN)

(21) Appl. No.: 19/140,574

(22) PCT Filed: Dec. 19, 2023
(86) PCT No.: PCT/CN2023/139735

§ 371 Date: Jun. 18, 2025

(30) Foreign Application Priority Data
Dec. 23, 2022 (CN) 202211663504.2

(51) Int. Cl. G06F 3/041; G06F 3/044

(52) U.S. Cl. CPC G06F 3/04184; G06F 3/04162; G06F 3/0441; G06F 3/0442

(57) ABSTRACT

An interaction method between an external object and a touch display device is provided, including: an image refresh cycle of the touch display device comprising a plurality of display driving periods and a plurality of non-display driving periods, the display driving periods alternating with the non-display driving periods, the plurality of non-display driving periods including a plurality of first touch periods and a plurality of second touch periods, the image refresh cycle including at least two second touch periods between two adjacent first touch periods; and the external object comprising at least one of an active object or a passive object, the touch display device receiving a communication signal from the active object, sensing a touch signal of the passive object during the plurality of first touch periods, and sensing a touch signal of the active object via the touch sensor during the plurality of second touch periods.

### TECHNICAL FIELD

The application relates to the field of display technologies, and specifically, to an interaction method between an external object and a touch display device, a touch processor, a computer-readable storage medium, a touch display device, and a touch system.

### BACKGROUND

With the development and progress of information technologies, the demand for touch display devices with both touch and display functions is gradually increasing. Display devices such as liquid crystal display devices, organic light-emitting diode display devices, and plasma display devices can be integrated with a touch function to form touch display devices. Touch display devices allow users to input information or commands in an intuitive and convenient way without using components such as a key, a keyboard or a mouse. Moreover, more and more application software requires high-precision touch for touch display devices, so the application of stylus pens (including active pens and passive pens) is increasing, and requirements for the performance of stylus pens are also gradually increasing. Pen touch technology can already achieve communication between stylus pens (for example, active pens) and touch display devices, and realize bidirectional data transmission between pens and touch display devices. Various communication methods between pens and touch display devices have been developed, but it is difficult for the existing communication methods to support the improvement in display performance of touch display devices.

### SUMMARY

An embodiment of the application provides an interaction method between an external object and a touch display device, the touch display device comprising a touch sensor, the method comprises: an image refresh cycle of the touch display device comprising a plurality of display driving periods and a plurality of non-display driving periods, the display driving periods alternating with the non-display driving periods, the plurality of non-display driving periods including a plurality of first touch periods and a plurality of second touch periods, each of the first touch periods or each of the second touch periods being one non-display driving period of the plurality of non-display driving periods, and the image refresh cycle including at least two second touch periods of the plurality of second touch periods between two adjacent first touch periods; and the external object comprising an active object or a passive object, the touch display device receiving a communication signal from the active object, sensing a touch signal of the passive object via the touch sensor during the plurality of first touch periods to detect a touch of the passive object on the touch display device, and sensing a touch signal of the active object via the touch sensor during the plurality of second touch periods to detect a touch of the active object on the touch display device.

In some embodiments, there exists at least one second touch period of the plurality of second touch periods between every two adjacent first touch periods of the plurality of first touch periods in the image refresh cycle.

In some embodiments, the image refresh cycle comprises eight second touch periods and four first touch periods, and there exist two second touch periods of the eight second touch periods between every two adjacent first touch periods of the four first touch periods.

In some embodiments, the image refresh cycle comprises four second touch periods and four first touch periods, and there exists one second touch period of the four second touch periods between every two adjacent first touch periods of the four first touch periods.

In some embodiments, the detecting the touch of the passive object on the touch display device and the detecting the touch of the active object on the touch display device comprise collecting the touch signal of the passive object sensed by the touch sensor and collecting the touch signal of the active object sensed by the touch sensor, respectively, the plurality of non-display periods further comprise a noise processing period, and the method further comprises: during the noise processing period, acquiring a signal-to-noise ratio of at least one of the touch signal of the active object and the touch signal of the passive object; and in response to the signal-to-noise ratio being lower than a threshold, adjusting a frequency of collecting the touch signal of the active object or the touch signal of the passive object.

In some embodiments, each first touch period of the plurality of first touch periods and each second touch period of the plurality of second touch periods have a same time length, and the time length does not exceed 180 microseconds.

In some embodiments, the plurality of non-display periods in the image refresh cycle further comprise a noise processing period, and sums of numbers of the first touch periods and the second touch periods on two sides of the noise processing period are equal to each other.

In some embodiments, the method further comprises: in response to the touch display device not receiving the communication signal from the active object, sensing the touch signal of the passive object via the touch sensor during the plurality of second touch periods to detect a touch of the passive object on the touch display device.

In some embodiments, the method further comprises: in response to the touch display device not receiving the communication signal from the active object, the touch display device not detecting the touch of the active object or the passive object on the touch display device during the plurality of first touch periods.

In some embodiments, the method further comprises: in response to the touch display device not receiving the communication signal from the active object, sensing the touch signal of the passive object via the touch sensor during the plurality of second touch periods and the plurality of first touch periods to detect the touch of the passive object on the touch display device.

In some embodiments, the image refresh cycle comprises six second touch periods and four first touch periods, and there exist two second touch periods between every two adjacent first touch periods of the four first touch periods.

In some embodiments, the image refresh cycle comprises five second touch periods and four first touch periods, and there exists one second touch period of the five second touch periods between every two adjacent first touch periods of the four first touch periods.

In some embodiments, the interaction method further comprising: the touch display device sending an uplink signal to the external object, and periodically sending the uplink signal to the external object by taking the image refresh cycle of the touch display device as a transmission period, the uplink signal comprising seven bits of data.

In some embodiments, the uplink signal is encoded with direct sequence spread spectrum, and each bit of data of the uplink signal is encoded as a P-bit spread spectrum code sequence, where P is a positive integer.

In some embodiments, each bit of data is encoded as a 31-bit spread spectrum code sequence.

In some embodiments, the touch signal of the active object comprises pressure information for indicating a touch pressure of the active object on the touch display device, and the pressure information comprises a multi-bit pressure information code, wherein the sensing the touch signal of the active object via the touch sensor during the plurality of second touch periods to detect the touch of the active object on the touch display device comprises: receiving different bits of pressure information code in the multi-bit pressure information code via the touch sensor during different second touch periods of the plurality of second touch periods respectively.

In some embodiments, the one image refresh cycle comprises eight second touch periods and four first touch periods, there exist two second touch periods of the eight second touch periods between every two adjacent first touch periods of the four first touch periods, and the pressure information comprises a twelve-bit pressure information code, the receiving different bits of pressure information code in the multi-bit pressure information code via the touch sensor during different second touch periods of the plurality of second touch periods respectively comprises: receiving the twelve-bit pressure information code via the touch sensor during six second touch periods of the eight second touch periods, respectively, and receiving two bits of pressure information code in the twelve-bit pressure information code via the touch sensor during each second touch period of the six second touch periods, respectively.

In some embodiments, the active object comprises a power source, the touch signal of the active object comprises power information for indicating a state of the power source, and the power information comprises a multi-bit power information code, wherein the sensing the touch signal of the active object via the touch sensor during the plurality of second touch periods to detect the touch of the active object on the touch display device comprises: receiving different bits of power information code in the multi-bit power information code via the touch sensor during different second touch periods of the plurality of second touch periods respectively.

In some embodiments, the power information comprises a four-bit power information code, and the receiving different bits of power information code in the multi-bit power information code via the touch sensor during different second touch periods of the plurality of second touch periods respectively comprises: receiving the four-bit power information code via the touch sensor during four second touch periods of the eight second touch periods, respectively.

In some embodiments, the active object comprises a plurality of keys, the touch signal of the active object comprises key information for indicating states of the plurality of keys, and the key information comprises a multi-bit key information code corresponding to the plurality of keys, wherein the sensing the touch signal of the active object via the touch sensor during the plurality of second touch periods to detect the touch of the active object on the touch display device comprises: receiving different bits of key information code in the multi-bit key information code via the touch sensor during different second touch periods of the plurality of second touch periods respectively.

In some embodiments, the touch signal of the active object comprises hovering information for indicating that the active object is in a hovering state, and identification information for indicating an identification of the active object, the hovering information comprises a hovering information code, and the identification information comprises an identification information code, the sensing the touch signal of the active object via the touch sensor during the plurality of second touch periods to detect the touch of the active object on the touch display device comprises: receiving the hovering information code and the identification information code via the touch sensor during different second touch periods of the plurality of second touch periods, respectively.

In some embodiments, the touch signal of the active object comprises a multi-bit touch signal code, and the multi-bit touch signal code comprises at least one selected from a group consisting of a multi-bit pressure information code, a multi-bit power information code, a multi-bit key information code, a hovering information code, an identification information code, and a check bit code, the sensing the touch signal of the active object via the touch sensor during the plurality of second touch periods to detect the touch of the active object on the touch display device comprises: receiving three to six bits of touch signal code in the multi-bit touch signal code via the touch sensor during each of the plurality of second touch periods.

In some embodiments, each bit of touch signal code in the three to six bits of touch signal code comprises a multi-bit pulse sequence, and multi-bit pulse sequences of different bits of touch signal code in the three to six bits of touch signal code have different phases.

Another embodiment of the application provides a touch processor, comprising: a memory configured to store computer-executable instructions; a data processor configured to perform the interaction method according to any one of the foregoing embodiments when the computer-executable instructions is executed by the data processor.

Another embodiment of the application provides a computer-readable storage medium comprising computer-executable instructions, when the computer-executable instructions are executed, the interaction method according to any one of the foregoing embodiments is implemented.

A further embodiment of the application provides a touch display device, comprising a touch sensor and a touch processor, the touch processor is configured to perform the interaction method according to any one of the foregoing embodiments.

Yet another embodiment of the application provides a touch system, comprising the touch display device according to the above embodiment and an active object, the active object is configured to send a downlink signal to the touch display device in response to receiving the uplink signal, and the downlink signal comprises the communication signal and the touch signal of the active object, wherein the active object comprises an active pen.

These and other advantages of the application will become apparent from and be set forth with reference to the embodiments described hereinafter.

### BRIEF DESCRIPTION OF DRAWINGS

Embodiments of the application will now be described in more detail and with reference to the accompanying drawings.

FIG. 1 schematically shows a touch of an external object on a touch display device;

FIG. 2 schematically shows a block diagram of a touch sensor and a touch processor in a touch display device according to an embodiment of the application;

FIG. 3 schematically shows a signal interaction between a touch display device and an active object according to an embodiment of the application;

FIG. 4 schematically shows some steps in a method for detecting a touch of an external object on a touch display device according to an embodiment of the application;

FIG. 5 schematically shows an example of a timing sequence of display driving periods and non-display driving periods within a single image refresh cycle in the case where an active object is sensed by a touch display device according to an embodiment of the application;

FIG. 6 schematically shows some steps in a method for detecting a touch of an external object on a touch display device according to another embodiment of the application;

FIG. 7 schematically shows an example of a timing sequence of display driving periods and non-display driving periods within a single image refresh cycle in the case where an active object is not sensed by a touch display device according to an embodiment of the application;

FIG. 8 schematically shows an example of a timing sequence of display driving periods and non-display driving periods within a single image refresh cycle in the case where an active object is sensed by a touch display device according to another embodiment of the application;

FIG. 9 schematically shows an example of a timing sequence of display driving periods and non-display driving periods within a single image refresh cycle in the case where an active object is not sensed by a touch display device according to another embodiment of the application;

FIG. 10 schematically shows an example of a timing sequence of display driving periods and non-display driving periods within a single image refresh cycle in the case where an active object is sensed by a further embodiment of the application;

FIG. 11 schematically shows an example of a timing sequence of display driving periods and non-display driving periods within a single image refresh cycle in the case where an active object is not sensed by a touch display device according to a further embodiment of the application;

FIG. 12 schematically shows an example of a timing sequence of display driving periods and non-display driving periods within a single image refresh cycle in the case where an active object is sensed by a touch display device according to another embodiment of the application;

FIG. 13 schematically shows an example of a timing sequence of display driving periods and non-display driving periods within a single image refresh cycle in the case where an active object is not sensed by a touch display device according to another embodiment of the application;

FIG. 14 schematically shows an example of a timing sequence of display driving periods and non-display driving periods within a single image refresh cycle in the case where an active object is sensed by a touch display device according to yet another embodiment of the application;

FIG. 15 schematically shows a signal code of an uplink signal sent by a touch display device according to an embodiment of the application to an active object;

FIG. 16 illustrates a pulse sequence of a three-bit touch signal code received via a touch sensor during each second touch period according to an embodiment of the application.

### DETAILED DESCRIPTION

Specific details of embodiments of the application will be provided in the description below, so that those skilled in the art can fully understand and implement the embodiments of the application. In some cases, the application does not illustrate or describe in detail some structures or functions well known in the art to avoid these unnecessary descriptions from obscuring the description of the embodiments of the application. The technical solution of the present patent application may be implemented in many different forms and purposes and should not be limited to the embodiments described herein. These embodiments are provided to make the technical solution of the application clear and complete, but the embodiments do not limit the protection scope of the patent application.

In the description of the application below, in the case that the details of the known functions and configurations related herein may make the subject matter of the application obscure rather than clear, these details will be omitted. In addition, the terms such as “first” and “second” mentioned herein are only used to distinguish corresponding elements from other elements, and the essence, order, sequence or number of the corresponding elements are not limited by these terms. When describing that a certain element is “connected to” or “linked to” another element, it should be understood that the element may not only be directly “connected to” or “linked to” another element, but also be “connected to” or “linked to” another element via a third element, or the third element may be between the certain element and the another element.

An embodiment of the application provides an interaction method between an external object and a touch display device. The “touch display device” mentioned herein refers to an electronic device with a touch function and an image display function, and a user can realize desired control of the device by touching one or some positions on the display screen of the electronic device. Examples of touch display devices include, but are not limited to, liquid crystal displays, organic light emitting diode displays, plasma displays, etc.

The “external object” mentioned herein is relative to the “touch display device”, that is, the external object does not belong to the touch display device. The external object refers to an object that can touch the screen of the touch display device and thus be identified by the touch display device when the touch display device is operating. The external object includes the user's fingers or other body parts, and may also include other touch tools that can be identified by the touch display device. Examples of touch tools include, but are not limited to, stylus pens, styluses, active pens, contact pins, touch sticks, etc. In the embodiment of the application, external objects are classified into active objects and passive objects. Active objects refer to touch tools that can receive and transmit signals, and usually carry a power supply element, such as a battery. Examples of active objects include, but are not limited to, active pens. Passive objects include touch tools that do not have a signal transceiving function. Examples of passive objects include, but are not limited to, contact pins and touch sticks that do not have a signal transceiving function. The user's fingers or other body parts that can perform touch operations on the touch display device are also classified herein as passive objects.

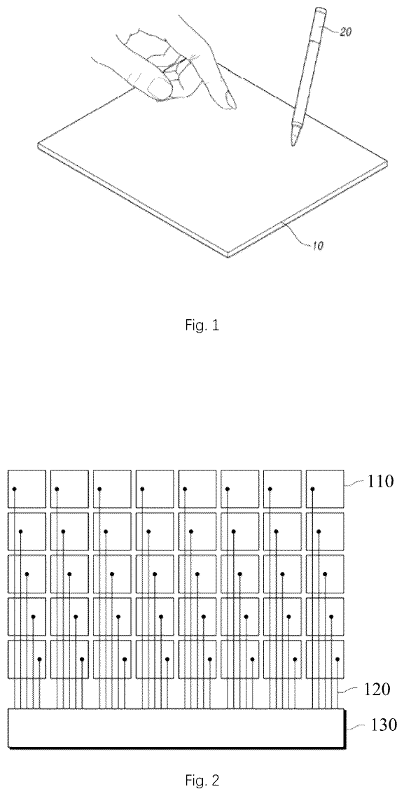

FIG. 1 schematically shows a touch of an external object on a touch display device. The external object and the touch display device can constitute a touch system. As shown in FIG. 1, both an active pen 20 and a user's finger can perform a touch operation on the display screen of a touch display device 10 to realize the user's desired operation to the touch display device.

According to an embodiment of the application, the touch display device comprises a touch sensor. The touch of an external object on the touch display device may cause a change in an electrical signal of the touch sensor, and the touch display device can determine whether the external object touches the touch display device and a specific touch position based on the change in the electrical signal of the touch sensor. For example, the touch display device can detect a touch of an external object based on the mutual-capacitance touch sensing principle or the self-capacitance touch sensing principle. FIG. 2 schematically shows an example of the structure of a touch sensor in a touch display device based on the self-capacitance touch sensing principle. As shown in FIG. 2, the touch sensor may comprise a plurality of touch electrodes 110, which may form an array of touch electrodes, and a layer structure where the touch electrodes reside may be referred to as a touch electrode layer. FIG. 2 also illustrates a touch processor 130, which is electrically connected to the plurality of touch electrodes 110 in the touch sensor via a plurality of signal lines 120, respectively. The touch processor 130 may apply a touch driving signal to each touch electrode 110, and may receive a touch sensing signal from the touch electrode 110. When an external object touches the touch display device, electrical signals on at least a portion of the touch electrodes (e.g., touch electrodes corresponding to the touch positions of the external object on the screen of the touch display device) may change. For example, capacitance values of the self-capacitances of the at least a portion of the touch electrodes may change due to the touch of the external object, and the touch processor 130 receives touch sensing signals indicating changes in the capacitance values via the signal lines 120, and accordingly determines that a touch event of the external object on the touch display device has occurred as well as specific touch positions. Alternatively, the touch display device may also detect a touch of an external object based on the mutual-capacitance touch sensing principle. In this case, the touch sensor may comprise a plurality of touch driving electrodes and a plurality of touch sensing electrodes, and the touch processor 130 may detect a touch of an external object based on changes in mutual capacitances between the touch driving electrodes and the touch sensing electrodes. That is, the touch sensor in the touch display device based on the self-capacitance touch sensing principle as shown in FIG. 2 does not constitute a limitation on the interaction method between an external object and a touch display device proposed by the embodiment of the application. In other words, the interaction method between an external object and a touch display device proposed in the embodiment of the application may also be applicable to a touch display device based on the mutual-capacitance touch sensing principle.

The touch display device comprises a display panel with an image function, and the touch sensor mentioned above may be arranged outside the display panel. For example, a touch panel including a touch sensor and a touch processor may be fabricated, and the touch panel and the display panel are combined to form a touch display device. Alternatively, the touch sensor may also be arranged inside the display panel, that is, the touch sensor is embedded into the display panel. In the case where the touch sensor is embedded into the display panel, when the display panel is being fabricated, the touch sensor may be formed together with electrodes or signal lines related to driving display in the display panel. For example, if the touch display device is implemented as a liquid crystal display, the common electrode in the liquid crystal display may be fabricated into multiple common electrode blocks and multiplexed as a touch sensor. The common electrode performs different functions in different time periods. For example, during a time period of driving the touch display device to display an image, a common voltage may be applied to each common electrode block, and during a time period of detecting a touch of an external object on the touch display device, a touch driving signal may be applied to common electrode blocks, or a touch sensing signal may be received from common electrode blocks. In the case where the touch display device is implemented as an organic light emitting diode display, the touch sensor may be formed on the surface of the organic light emitting diode display panel, for example, on an encapsulation layer of the organic light emitting diode display panel.

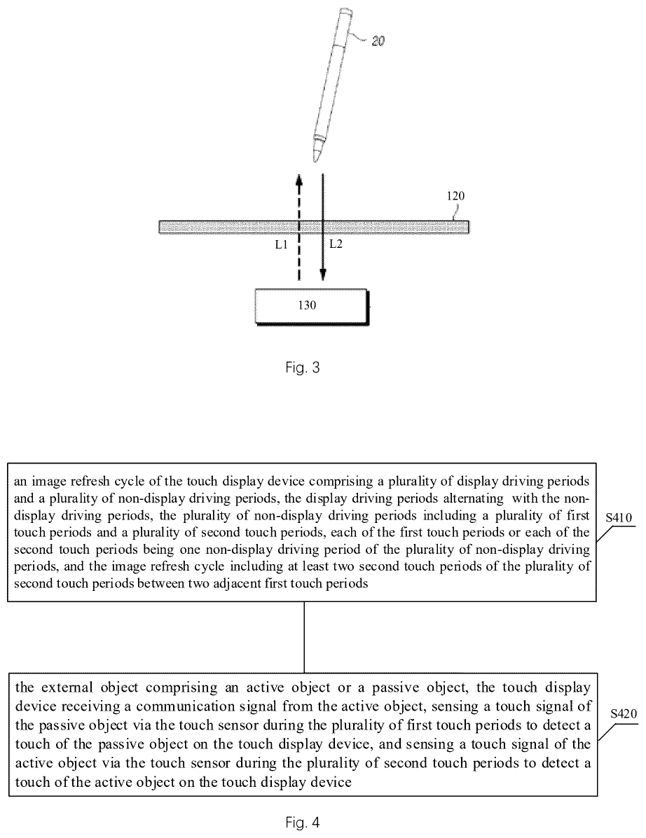

FIG. 3 schematically shows a signal interaction between a touch processor 130 in a touch display device and an active object (active pen 20). As shown in FIG. 3, the touch processor 130 may send signals to the active pen 20 or receive signals from the active pen 20 via the touch sensor 120. The paths for the touch processor 130 to send signals to and receive signals from the active pen 20 are illustrated as L1 and L2 in FIG. 3, respectively. The signal transmitted from the touch processor 130 to the active object 20 via the touch sensor 120 is referred to as an uplink signal herein, and the signal transmitted from the active object 20 to the touch processor 130 via the touch sensor 120 is referred to as a downlink signal herein.

The touch processor 130 may be implemented as a single or multiple integrated circuit chips. According to an embodiment of the application, the touch processor comprises a sensing driver and a touch controller, and the sensing driver is electrically connected to the touch sensor to sense changes in electrical signals (e.g., the capacitance values of self-capacitances) of the touch sensor, so that it can be determined whether the external object touches the touch display device. The touch controller is electrically connected to the sensing driver and can receive downlink signals sent by the active object. The touch controller further determines touch states (such as the touch position, pressure, tilt angle, battery power, etc. of the external object) related to the external object based on changes in the electrical signals of the touch sensor sensed by the sensing driver or based on the downlink signals sent by the active object. In FIG. 2 and FIG. 3, the touch processor 130 is illustrated as a single integrated circuit chip. In other embodiments, different functional modules in the touch processor 130 may be implemented as independent integrated circuit chips, for example, the sensing driver and the touch controller are implemented as different integrated circuit chips.

The interaction method between an external object and a touch display device proposed by an embodiment of the application will be described below with reference to FIG. 4. As shown in FIG. 4, the method comprises: S410, an image refresh cycle of the touch display device comprising a plurality of display driving periods and a plurality of non-display driving periods, the display driving periods alternating with the non-display driving periods, the plurality of non-display driving periods including a plurality of first touch periods and a plurality of second touch periods, each of the first touch periods or each of the second touch periods being one non-display driving period of the plurality of non-display driving periods, and the image refresh cycle including at least two second touch periods of the plurality of second touch periods between two adjacent first touch periods; and S420, the external object comprising an active object or a passive object, the touch display device receiving a communication signal from the active object, sensing a touch signal of the passive object via the touch sensor during the plurality of first touch periods to detect a touch of the passive object on the touch display device, and sensing a touch signal of the active object via the touch sensor during the plurality of second touch periods to detect a touch of the active object on the touch display device. The image refresh cycle mentioned here refers to a time period in which the touch display device displays a frame of image. The image refresh cycle corresponds to an image refresh frequency. For example, if the image refresh frequencies of the touch display device are 60 Hz or 90 Hz respectively, the image refresh cycles are 1/60 seconds and 1/90 seconds respectively. In addition, the statement in the above step S410 that “the image refresh cycle including at least two second touch periods of the plurality of the second touch periods between two adjacent first touch periods” does not limit whether there is another first touch period between the two second touch periods. That is to say, there may be no first touch period between the above two second touch periods. For example, there is only a display driving period between the above two second touch periods, or there may be a display driving period and another first touch period between the above two second touch periods, which will be further described below by way of example.

The interaction method between an external object and a touch display device proposed by the above embodiment of the application can be periodically executed with an image refresh cycle of the touch display device. FIG. 5 schematically shows an example of a timing sequence of the display driving periods and the non-display driving periods (including the first touch periods and the second touch periods) within a time period of a single image refresh cycle Tf of the touch display device. In some embodiments, the touch display device may send an uplink signal to an external object to establish a connection between the external object and the touch display device. In FIG. 5, the time period in which the touch display device sends an uplink signal to the external object is identified as B, and the image refresh cycle Tf can also be understood as a transmission cycle for the touch display device to send an uplink signal to the external object.

As shown in FIG. 5, the touch display device sends an uplink signal to the external object during the time period B. If the touch display device receives a communication signal from the external object, such as an ACK (acknowledgement character) signal, this indicates that the touch display device has found an active object (e.g., an active pen) and has established a connection with the active object. A time period (i.e., an image refresh cycle) in which the touch display device displays a frame of image includes a plurality of display driving periods D and a plurality of non-display driving periods, and the display driving periods D alternate with the non-display driving periods. The plurality of non-display driving periods include a plurality of first touch periods T3, T6, T10, T13 and a plurality of second touch periods T1, T2, T4, T5, T8, T9, T11, T12. Each of the first touch periods or each of the second touch periods is one non-display driving period of the plurality of non-display driving periods. As shown in FIG. 5, a single image refresh cycle includes at least two second touch periods (e.g., second touch periods T4 and T5) between two adjacent first touch periods (e.g., first touch periods T3 and T6). In this example, there is only a display driving period D between the above-mentioned at least two second touch periods (e.g., second touch periods T4 and T5). During each display driving period D, pixels of the touch display device displays an image under the driving of a pixel driving circuit and a gate scanning circuit of the touch display device. During the plurality of first touch periods T3, T6, T10 and T13, a touch signal of a passive object is sensed via a touch sensor to detect a touch of the passive object on the touch display device. If a passive object (e.g., a user's finger) touches the touch display device, the passive object will affect electrical signals of the touch sensor. For example, charges on the touch electrode change, causing the self-capacitance of the touch electrode to change, a change in an electrical signal of the touch sensor can be regarded as a touch signal of the passive object, and the touch processor can collect the touch signal to detect a touch of the passive object on the touch display device, for example, to determine a touch position of the passive object. If no passive object touches the touch display device, during the first touch periods T3, T6, T10 and T13, the electrical signals of the touch sensor do not change, and the touch processor determines that no passive object is detected. That is, in the time period Tf of displaying each frame of the image, the touch processor of the touch display device detects a touch of the passive object on the touch display device during the first touch periods T3, T6, T10 and T13. During the plurality of second touch periods T1, T2, T4, T5, T8, T9, T11 and T12, the touch display device senses a touch signal of the active object via the touch sensor to detect a touch of the active object on the touch display device. If an active object (e.g., an active pen) touches the touch display device, the active object will cause a change in an electrical signal of the touch sensor, and meanwhile, the active object may further send a downlink signal to the touch display device. The touch processor receives the downlink signal via the touch sensor, and then can determine not only a touch position of the active object, but also other touch states (such as the touch pressure, the posture of the active object, etc.) related to the active object.

With such a timing sequence arrangement for the display driving periods, the first touch periods and the second touch periods in the image refresh cycle, compared with the interaction method between an external object and a touch display device realized based on a conventional communication protocol between an external object and a touch display device, this method can decrease the proportion of the total time length of the first touch periods and the second touch periods in the image refresh cycle without affecting the detection of touches of the active object and the passive object, so that each image refresh cycle includes a longer display driving period, which is very beneficial for further improving the image display quality of the touch display device, for example, it can support the implementation of a touch display device with a higher image refresh rate and a higher PPI (pixels per inch).

In some embodiments, there is at least one second touch period between every two adjacent first touch periods in one image refresh cycle. As shown in FIG. 5, there are two second touch periods of the second touch periods T1, T2, T4, T5, T8, T9, T11 and T12 between every two adjacent first touch periods of the first touch periods T3, T6, T10 and T13. For example, second touch periods T4 and T5 are between the first touch periods T3 and T6, second touch periods T8 and T9 are between the first touch periods T6 and T10, and second touch periods T11 and T12 are between the first touch periods T10 and T13. In the embodiment shown in FIG. 5, the image refresh cycle Tf includes eight second touch periods and four first touch periods, and two second touch periods are between every two adjacent first touch periods. The image refresh cycle Tf further includes thirteen display driving periods D. The image refresh frequency of the touch display device may be 60 Hz or 90 Hz, and then the image refresh cycle Tf shown in FIG. 5 is 1/60 seconds or 1/90 seconds, respectively. Even if an active object such as an active pen and a user's finger touch the touch display device at the same time, the touch display device can detect the touches of both the active pen and the finger on the touch display device during each image refresh cycle Tf.

The touch signal of the passive object and the touch signal of the active object mentioned here and below may contain different information contents. The touch signal of the passive object includes a change in an electrical signal of the touch sensor resulting from the touch of the passive object on the touch display device, and the touch signal of the active object includes a change in an electrical signal of the touch sensor resulting from the touch of the active object on the touch display device, as well as a downlink signal transmitted by the active object to the touch display device.

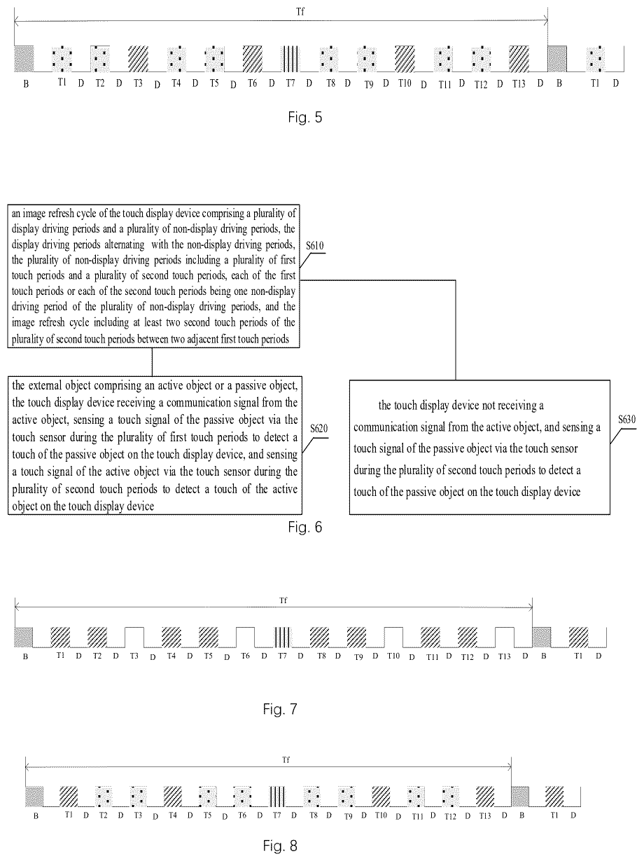

According to another embodiment of the application, as shown in FIG. 6, the interaction method between an external object and a touch display device further comprises: S630, the touch display device not receiving a communication signal from the active object, and sensing a touch signal of the passive object via the touch sensor during the plurality of second touch periods to detect a touch of the passive object on the touch display device. Steps S610 and S620 shown in FIG. 6 are the same as steps S410 and S420 shown in FIG. 4, and are not repeated here.

Next, referring to FIG. 7, in the case where the touch display device does not receive a communication signal from the external object, the touch display device determines that there is no active object nearby, and sense a touch signal of the passive object via the touch sensor during the second touch periods T1, T2, T4, T5, T8, T9, T11 and T12 to detect a touch of the passive object on the touch display device. If the passive object (for example, the user's finger) touches the touch display device, the electrical signal of the touch sensor changes, thereby obtaining a touch signal of the passive object, and the touch processor detects a touch of the passive object on the touch display device based on the touch signal. If there is no passive object touching the touch display device, during the second touch periods T1, T2, T4, T5, T8, T9, T11 and T12, the electrical signal of the touch sensor does not change, and the touch display device determines that no passive object is detected. That is, in this embodiment, if the touch display device determines that there is no active object nearby, it detects whether there is a passive object touching the touch display device during the second touch periods. During the first touch periods T3, T6, T10 and T13 shown in FIG. 7, the touch display device does not detect a touch of the external object (including the active object and the passive object), thereby reducing the load of the touch processor and decreasing the power consumption of the touch display device.

Alternatively, in another embodiment, in the case where the touch display device does not receive a communication signal from the active object, at least a portion of the first touch periods T3, T6, T10 and T13 can be used as a noise processing period. In this case, the interaction method between an external object and a touch display device further comprises: acquiring a signal-to-noise ratio of at least one of the touch signal of the active object and the touch signal of the passive object during the noise processing period; and in response to the signal-to-noise ratio being lower than a threshold, adjusting a frequency of collecting the touch signal of the active object or the passive object.

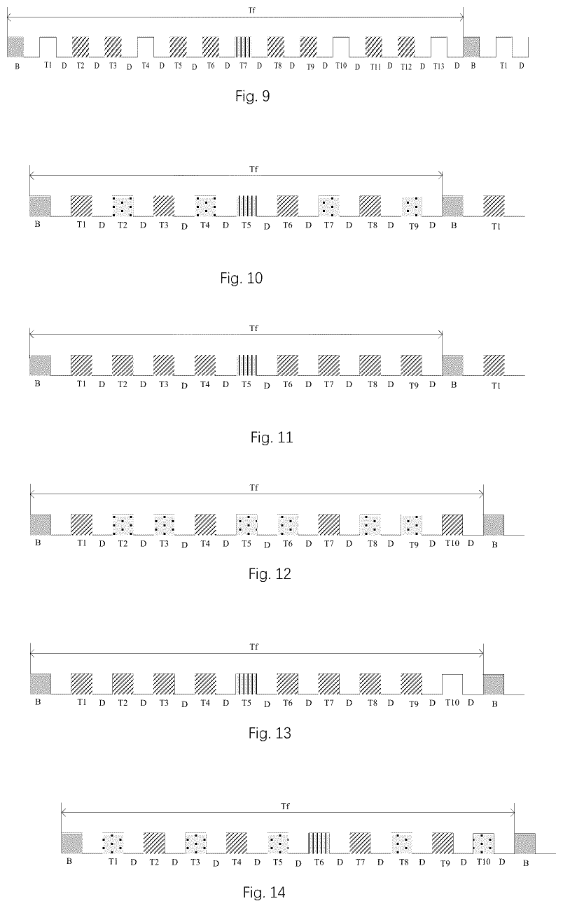

FIG. 8 illustrates an example of a timing sequence of display driving periods, first touch periods and second touch periods within a time period of a single image refresh cycle Tf of a touch display device according to another embodiment of the application. As shown in FIG. 8, the image refresh cycle Tf includes thirteen display driving periods D for image display, eight second touch periods (i.e., T2, T3, T5, T6, T8, T9, T11, T12), and four first touch periods (i.e., T1, T4, T10, T13). One image refresh cycle Tf includes at least two second touch periods (e.g., T5, T6, T8, T9) between two adjacent first touch periods (e.g., T4, T10). There are two second touch periods T2 and T3 between adjacent first touch periods T1 and T4, four second touch periods T5, T6, T8 and T9 between adjacent first touch periods T4 and T10, and two second touch periods T11 and T12 between adjacent first touch periods T10 and T13. For the embodiment shown in FIG. 8, the touch display device sends an uplink signal to an external object during a time period B. If the touch display device receives a communication signal from the external object, it indicates that the touch display device senses the presence of an active object. During the second touch periods T2, T3, T5, T6, T8, T9, T11 and T12, a touch signal of the active object is sensed via the touch sensor to detect a touch of the active object on the touch display device. During the first touch periods T1, T4, T10 and T13, a touch signal of the passive object is sensed via the touch sensor to detect a touch of the passive object on the touch display device. As shown in FIG. 9, if the touch display device does not receive a communication signal from the external object, it indicates that the touch display device does not sense an active object. During the second touch periods T2, T3, T5, T6, T8, T9, T11 and T12, a touch signal of the passive object is sensed via the touch sensor to detect a touch of the passive object on the touch display device. During the first touch periods T1, T4, T10 and T13, the touch display device does not detect a touch of the external object.

FIG. 10 illustrates an example of a timing sequence of display driving periods, first touch periods, and second touch periods within a single image refresh cycle Tf of a touch display device according to a further embodiment of the application. In this embodiment, the image refresh cycle Tf includes four second touch periods T2, T4, T7, T9 and four first touch periods T1, T3, T6, T8. One image refresh cycle Tf includes at least two second touch periods between two adjacent first touch periods. In this example, an additional first touch period is further included between the at least two second touch periods mentioned above. For example, the second touch period T2 is between two adjacent first touch periods T1 and T3, the second touch period T4 is between two adjacent first touch periods T3 and T6, and the second touch period T7 is between two adjacent first touch periods T6 and T8. Moreover, there is a second touch period between every two adjacent first touch periods of the four first touch periods. For example, a second touch period T2 is between the first touch periods T1 and T3, a second touch period T4 is between the first touch periods T3 and T6, and a second touch period T7 is between the first touch periods T6 and T8. In the embodiment of FIG. 10, the image refresh frequency of the touch display device is 90 Hz or higher. The touch display device sends an uplink signal to the external object during the time period B. If the touch display device receives a communication signal from the external object, it indicates that the touch display device senses the presence of an active object. During the second touch periods T2, T4, T7 and T9, a touch signal of the active object is sensed via the touch sensor to detect a touch of the active object on the touch display device. During the first touch periods T1, T3, T6 and T8, a touch signal of the passive object is sensed via the touch sensor to detect a touch of the passive object on the touch display device. As shown in FIG. 11, if the touch display device does not receive a communication signal from the external object, it indicates that the touch display device does not sense an active object. During the second touch periods T2, T4, T7, T9 and the first touch periods T1, T3, T6, T8, a touch signal of the passive object is received via a touch sensor to sense a touch of the passive object on the touch display device.

According to some embodiments of the application, detecting a touch of the passive object on the touch display device and detecting a touch of the active object on the touch display device respectively comprise collecting a touch signal of the passive object sensed by the touch sensor and collecting a touch signal of the active object sensed by the touch sensor. For example, the touch processor can collect a change in an electrical signal of the touch sensor and a downlink signal transmitted by the active object. The plurality of non-display periods further include a noise processing period. In this case, the interaction method between an external object and a touch display device further comprises the following steps: during the noise processing period, acquiring a signal-to-noise ratio of at least one of the touch signal of the active object and the touch signal of the passive object; and in response to the signal-to-noise ratio being lower than a threshold, adjusting a frequency of collecting the touch signal of the active object or the passive object.

Referring back to FIG. 5 and FIG. 7 to FIG. 9, during each image refresh cycle Tf, the plurality of non-display periods also include a noise processing period T7, during which a controller (e.g., a touch processor) in the touch display device may calculate a signal-to-noise ratio of at least one of the touch signal of the active object and the touch signal of the passive object. The touch signal of the active object or the touch signal of the passive object may contain an interference signal, which may originate from the touch display device itself or the surrounding environment. If the signal-to-noise ratio of the touch signal of the active object or the touch signal of the passive object is lower than a threshold, the frequency of collecting the touch signal of the active object or the frequency of collecting the touch signal of the passive object will be adjusted. In some embodiments, the frequency of collecting the touch signal of the active object or the passive object (which may be referred to as a sampling frequency) is between 200 KHz and 400 KHz. In the case where the signal-to-noise ratio of the touch signal of the active object or the touch signal of the passive object is lower than a threshold, the frequency of collecting the touch signal of the active object or the passive object is adjusted so that the sampling frequency avoids the frequency of the interference signal, thereby reducing the influence of the interference signal on the detection of a touch of the external object on the touch display device.

In FIG. 10 and FIG. 11, the noise processing period is identified as T5. Further, in other embodiments, if the signal-to-noise ratio of the touch signal of the active object or the touch signal of the passive object is lower than a threshold, it is also possible to adjust the frequency with which the active object sends a downlink signal to the touch display device, thereby further reducing the influence of the interference signal on the detection of a touch of the external object on the touch display device.

According to some embodiments of the application, each of the plurality of first touch periods and each of the plurality of second touch periods has a same time length, and the time length does not exceed 180 microseconds. For example, referring to FIG. 5 and FIG. 7, the first touch periods T3, T6, T10, T13 and the second touch periods T1, T2, T4, T5, T8, T9, T11, T12 have the same duration, and none of them exceeds 180 microseconds. In FIG. 8 and FIG. 9, the eight second touch periods T2, T3, T5, T6, T8, T9, T11, T12 and the four first touch periods T1, T4, T10, T13 also have the same time length. Further, in some embodiments, the noise processing period T7 has the same time length as each first touch time or each second touch period, and the noise processing period T7 does not exceed 180 microseconds. For the embodiments of FIG. 10 and FIG. 11, each of the second touch periods T2, T4, T7, T9, each of the first touch periods T1, T3, T6, T8 and the noise processing period T5 may have the same time length.

According to some embodiments of the application, the plurality of first touch periods and the plurality of second touch periods are distributed on two sides of the noise processing period in a symmetrical manner in terms of time length, that is, the sums of numbers of the first touch periods and the second touch periods on two sides of the noise processing period are equal to each other. This means that during each image refresh cycle or a time period of displaying each frame of image, the overall durations of the first touch periods and the second touch periods on two sides of the noise processing period are the same. If each first touch period and each second touch time have the same time length, the total numbers of first touch periods and second touch periods on two sides of the noise processing period are the same. For example, as shown in FIG. 5, the second touch periods T1, T2, T4, T5, the first touch periods T3, T6 and the second touch periods T8, T9, T11, T12, the first touch periods T10, T13 are distributed on two sides of the noise processing period T7 in a symmetrical manner in terms of time length. Before the noise processing period T7, there are six time periods, namely, the second touch periods T1, T2, T4, T5 and the first touch periods T3, T6, and after the noise processing period T7, there are also six time periods, namely, the second touch periods T8, T9, T11, T12 and the first touch periods T10, T13. Similarly, as shown in FIG. 10, the first touch periods T1, T3, T6, T8 and the second touch periods T2, T4, T7 and T9 are distributed on two sides of the noise processing period T5 in a symmetrical manner in terms of time length. However, the technical solution of the application is not so limited. In other embodiments, the noise processing period may be interchanged with any first touch period or any second touch period in terms of time. In this case, the plurality of first touch periods and the plurality of second touch periods are distributed on two sides of the noise processing period in an asymmetrical manner in terms of time length. In a further embodiment, the time length of the noise processing period may be different from the time length of the first touch period or the second touch period.

FIG. 12 schematically shows an example of a timing sequence of display driving periods and non-display driving periods within a single image refresh cycle in the case where an active object is sensed by a touch display device according to another embodiment of the application. In the example of FIG. 12, one image refresh cycle includes six second touch periods T2, T3, T5, T6, T8, T9 and four first touch periods T1, T4, T7, T10, and there are two second touch periods between every two adjacent first touch periods of the four first touch periods T1, T4, T7 and T10. FIG. 13 schematically shows an example of a timing sequence of display driving periods and non-display driving periods within a single image refresh cycle in the case where an active object is not sensed by a touch display device according to the embodiment shown in FIG. 12. In the case where the touch display device does not sense an active object, during the second touch periods T2, T3, T6, T8, T9 and the first touch periods T1, T4, T7, a touch signal of the passive object is received via the touch sensor to detect a touch of the passive object on the touch display device. During the first touch period T10 shown in FIG. 13, the touch display device does not detect a touch of the external object (including the active object and the passive object), thereby reducing the load of the touch processor and decreasing the power consumption of the touch display device. The non-display period further includes a noise processing period T5. In other embodiments, the noise processing period T5 can be omitted, or the touch display device senses a touch signal of the passive object via the touch sensor during all six second touch periods T2, T3, T5, T6, T8, T9 and four first touch periods T1, T4, T7, T10 to detect a touch of the passive object on the touch display device.

FIG. 14 schematically shows an example of a timing sequence of display driving periods and non-display driving periods within a single image refresh cycle in the case where an active object is sensed by a touch display device according to yet another embodiment of the application. In this example, one image refresh cycle includes five second touch periods T1, T3, T5, T8, T10 and four first touch periods T2, T4, T7, T9, and there is one second touch period between every two adjacent first touch periods of the four first touch periods T2, T4, T7 and T9. One image refresh cycle Tf includes at least two second touch periods between two adjacent first touch periods. For example, the second touch period T3 is between two adjacent first touch periods T2 and T4, the second touch period T5 is between two adjacent first touch periods T4 and T7, and the second touch period T8 is between two adjacent first touch periods T7 and T9. In FIG. 14, the noise processing period is identified as T6.

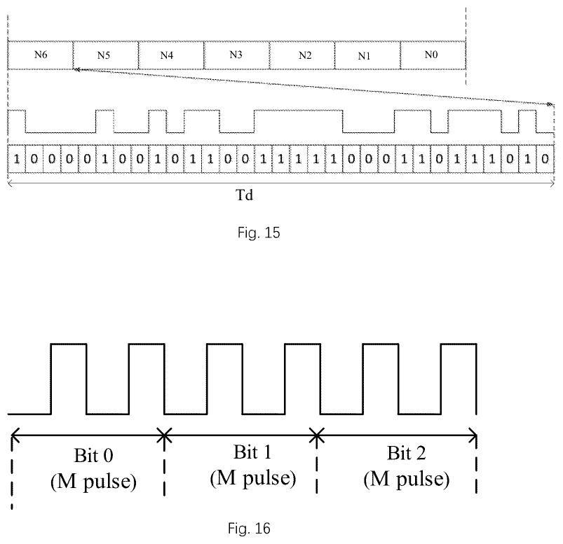

According to some embodiments of the application, the interaction method between an external object and a touch display device further comprises: the touch display device sending an uplink signal to the external object, and periodically sending the uplink signal to the external object by taking the image refresh cycle of the touch display device as a transmission period, the uplink signal including seven bits of data. For example, as shown in FIG. 5 and FIG. 7 to FIG. 11, the touch display device sends an uplink signal to the external object during the time period B, and the transmission period of the uplink signal is the image refresh cycle Tf. The uplink signal may define a collaborative operation between the touch display device and the active object (e.g., an active pen) or include a control signal required for the driving operation of the active object. For example, the uplink signal may include identification information, type information of the touch display device, characteristic information (e.g., frequency, number of pulses) of the downlink signal sent by the active object, and information for synchronization between the active object and the touch display device. In some embodiments, the uplink signal may be encoded using direct sequence spread spectrum (DSSS), and each bit of data is encoded as a P-bit spread spectrum code sequence, where P is a positive integer. The direct sequence spread spectrum (DSSS) technology encodes one bit of data into a multi-bit sequence (the multi-bit sequence can be called a “chip”). For example, data “0” is encoded with a chip “00100111000”, data “1” is encoded with a chip “11011000111”, and the data string “010” is encoded as “00100111000”, “11011000111” and “00100111000”. On the surface, the use of direct sequence spread spectrum technology requires a higher bandwidth, but the cost is worth it. In some embodiments, each bit of data is encoded as a 31-bit spread spectrum code sequence. For example, the uplink signal transmits 7 characters of ‘0’ or ‘1’, and each character is expanded into a 31-bit string of ‘0’ or ‘1’, that is, the uplink signal includes 7 bits of data, and each bit of data is encoded as a 31-bit spread spectrum code sequence, so that the uplink signal includes 217 bits of spread spectrum code sequences in total. The uplink signal may also be described as including a 7-bit code, and each bit of code includes a 31-bit pulse sequence, that is, each bit of code is represented by a 31-bit pulse sequence, and the pulse potential of each bit in the 31-bit pulse sequence corresponds to “0” or “1”. Different bits of code in the 7-bit code may include different 31-bit pulse sequences. FIG. 15 illustrates an example of a 7-bit code in an uplink signal. Each bit of code in the 7-bit code N0~N6 includes a 31-bit pulse sequence, and accordingly, the uplink signal includes a 217-bit pulse sequence. According to an embodiment of the application, the duration of each bit of pulse is 1 microsecond, and the duration Td of the pulse to which each bit of code corresponds is 31 microseconds. Partial codes of the 7-bit code are used to achieve signal synchronization between the touch display device and the active object, and some codes can represent identification information, type information of the touch display device, and characteristic information (e.g., frequency, number of pulses) of the downlink signal sent by the active object. Those skilled in the art can assign specific information content to each bit of code in the 7-bit code according to actual applications, and no specific restrictions are made here.

When connection between the active object and the touch display device have been established, the active object may transmit a downlink signal to the touch display device. The downlink signal is sensed by the touch sensor, and the touch display device can determine the touch state of the active object based on the downlink signal. The information content of the downlink signal may be set according to actual application demands. In some embodiments, the downlink signal may include the serial number of the active object, the key state of the active object, touch pressure information of the active object, power information of the active object, and information for error detection and correction, etc.

According to some embodiments of the application, the touch signal (e.g., a downlink signal) of the active object includes pressure information for indicating a touch pressure of the active object on the touch display device, and the pressure information includes a multi-bit pressure information code. Sensing the touch signal of the active object via the touch sensor during the plurality of second touch periods to detect the touch of the active object on the touch display device comprises: receiving different bits of pressure information code in the multi-bit pressure information code via the touch sensor during different second touch periods of the plurality of second touch periods, respectively.

For the previously described embodiment in which the image refresh cycle includes eight second touch periods and four first touch periods, there are two second touch periods between every two adjacent first touch periods. In this case, the pressure information may include a twelve-bit pressure information code, and the step of receiving different bits of pressure information code in the multi-bit pressure information code via the touch sensor during different second touch periods of second touch periods, respectively comprises: receiving the twelve-bit pressure information code via the touch sensor during six second touch periods of the eight second touch periods, and receiving two bits of pressure information code in the twelve-bit pressure information code via the touch sensor during each of the six second touch periods, respectively.

An example of receiving different bits of pressure information code of the multi-bit pressure information code via the touch sensor will be further explained in conjunction with Table 1 and FIG. 5. Table 1 below schematically shows an exemplary format of a downlink signal received by the touch display device.

As shown in FIG. 5, the image refresh cycle includes eight second touch periods T1, T2, T4, T5, T8, T9, T11 and T12. As shown in Table 1, during the second touch periods T1, T2, T4, T8, T9 and T11, twelve bits of pressure information code “pressure 0”, “pressure 1” . . . “pressure 11” are received via the touch sensor, and during each of the six second touch periods T1, T2, T4, T8, T9 and T11, two bits of pressure information code in the twelve bits of pressure information code are received via the touch sensor. For example, during the second touch period T11, the touch display device receives “pressure 0” and “pressure 1” from the active object (e.g., an active pen) via the touch sensor, during the second touch period T9, the touch display device receives “pressure 2” and “pressure 3” from the active object (e.g., an active pen) via the touch sensor, and during the second touch period T1, the touch display device receives “pressure 10” and “pressure 11” from the active object (e.g., an active pen) via the touch sensor. Therefore, the touch pressure information represented by the twelve-bit pressure information code is received by the touch display device in a time-dispersed manner, which helps the touch display device to be compatible with an active object (e.g., an active pen) with a higher reporting rate. In other words, if the active pen currently matched with the touch display device is upgraded to an active pen with a higher reporting rate, the accuracy and reliability of the upgraded active pen's reporting rate can also be well guaranteed.

TABLE 1

| time period | code bit | data |
|---|---|---|
| T1 | Bit 2 | Pen number |
| | Bit 1 | Pressure 11 |
| | Bit 0 | Pressure 10 |
| T2 | Bit 2 | H/I |
| | Bit 1 | Pressure 9 |
| | Bit 0 | Pressure 8 |
| T4 | Bit 2 | Key 1 |
| | Bit 1 | Pressure 7 |
| | Bit 0 | Pressure 6 |
| T5 | Bit 2 | Key 0 |
| | Bit 1 | CRC 3 |
| | Bit 0 | CRC 2 |
| T8 | Bit 2 | Power 3 |
| | Bit 1 | Pressure 5 |
| | Bit 0 | Pressure 4 |
| T9 | Bit 2 | Power 2 |
| | Bit 1 | Pressure 3 |
| | Bit 0 | Pressure 2 |
| T11 | Bit 2 | Power 1 |
| | Bit 1 | Pressure 1 |
| | Bit 0 | Pressure 0 |
| T12 | Bit 2 | Power 0 |
| | Bit 1 | CRC 1 |
| | Bit 0 | CRC 0 |

According to some embodiments of the application, the active object includes a power source, and the touch signal of the active object includes power information for indicating the state of the power source, for example, the downlink signal transmitted by the active object to the touch display device includes power information. The power information includes a multi-bit power information code. In this case, the step of sensing a touch signal of the active object via the touch sensor during the plurality of second touch periods to detect a touch of the active object on the touch display device comprises: receiving different bits of power information code in the multi-bit power information code via the touch sensor during different second touch periods of second touch periods. For example, as shown in Table 1 above, the power information includes four bits of power information code “power 0”, “power 1”, “power 2” and “power 3”. A respective one bit of power information code is received via the touch sensor during the second touch periods T12, T11, T9 and T8, respectively. That is, the four bits of power information code are received via the touch sensor during four second touch periods of the eight second touch periods, respectively. In the example shown in Table 1, the touch pressure information of the active object includes a twelve-bit pressure information code, so the touch pressure determined by the touch display device may include 4096 gradients. The power information includes a four-bit power information code, and the power state of the active object can be expressed into 16 gradients.

In some embodiments, the active object includes a plurality of keys. The touch signal of the active object includes key information for indicating the states of the plurality of keys, and the key information includes a multi-bit key information code corresponding to the plurality of keys. In this case, the step of sensing the touch signal of the active object via the touch sensor during the plurality of second touch periods to detect the touch of the active object on the touch display device includes: receiving different bits of key information code in the multi-bit key information code via the touch sensor during different second touch periods of the plurality of second touch periods, respectively. For example, as shown in Table 1, key information code “key 0” and “key 1” are received during the second touch periods T5 and T4, respectively. The key information code “key 0” and “key 1” may correspond to different keys of the active object, respectively.

Further, in some embodiments, the touch signal of the active object includes hovering information for indicating that the active object is in a hovering state, and identification information for indicating an identification of the active object. The hovering information includes a hovering information code, and the identification information includes an identification information code. In this case, the step of sensing a touch signal of the active object via the touch sensor during the plurality of second touch periods to detect a touch of the active object on the touch display device comprises: receiving the hovering information code and the identification information code via the touch sensor during different second touch periods of the plurality of second touch periods, respectively. For example, in the example shown in Table 1, during the second touch period T1, the touch display device receives an identification information code “pen number” of the active object, and during the second touch period T2, the touch display device receives a hovering information code “H/I”.

Therefore, according to an embodiment of the application, the touch signal of the active object includes a multi-bit touch signal code, and the multi-bit touch signal code includes the multi-bit pressure information code, the multi-bit power information code, the multi-bit key information code, the hovering information code, and the identification information code. The multi-bit touch signal code of the touch signal of the active object may also include a check bit code, for example, four bits of check code CRC 0, CRC 1, CRC 2 and CRC 3 shown in Table 1. However, the embodiments of the application are not so limited, and the touch signal of the active object may further include any other appropriate information code. In some embodiments, the step of sensing a touch signal of the active object via the touch sensor during the plurality of second touch periods to detect a touch of the active object on the touch display device comprises: during each of the second touch periods, receiving three to six bits of touch signal code in the multi-bit touch signal code via the touch sensor.

For the example shown in Table 1, three bits of touch signal code in the multi-bit touch signal code are received via the touch sensor during each of the second touch periods. During each of the second touch periods T1, T2, T4, T5, T8, T9, T11 and T12, the three bits of touch signal code are represented as Bit 0, Bit 1 and Bit 2.

According to some embodiments of the application, each bit of touch signal code in the three to six bits of touch signal code includes a multi-bit pulse sequence, and the multi-bit pulse sequences of different bits of touch signal code in the three to six bits of touch signal code have different phases. For example, as shown in FIG. 16, each bit of code Bit 0, Bit 1 or Bit 2 of the three bits of touch signal code includes a multi-bit pulse sequence (for example, each includes M pulses), but the pulse sequences for different bits of code may have different phases. For example, the phases of the pulse sequences for the touch signal code Bit 0 and Bit 1 may differ by 180 or 90 degrees, so as to represent information contents of different bits of touch signal code.

According to some embodiments of the application, the downlink signal is encoded by means of differential binary phase shift encoding, for example, supporting at least one of the three modes of BPSK, D-BPSK and Q-DPSK, digital information is transmitted by utilizing a carrier wave relative phase change, for example, transmitting digital information using a carrier wave relative phase change between adjacent code elements.

Another embodiment of the application provides a touch processor, comprising: a memory configured to store computer-executable instructions; a data processor configured to execute the method described in the foregoing embodiments of the interaction method between an external object and a touch display device when the computer-executable instructions are executed by the data processor.

The steps in the method described in the foregoing embodiments of the interaction method between an external object and a touch display device can be implemented as a computer program. An embodiment of the present application provides a computer program product, which comprises a computer program carried on a computer-readable medium, and the computer program contains a program code for executing at least one step in the interaction method between an external object and a touch display device described in the foregoing embodiments.

Another embodiment of the application provides one or more computer-readable storage media, on which computer-readable instructions are stored, and when the computer-readable instructions are executed, the interaction method between an external object and a touch display device according to the embodiments of the application is implemented. The various steps of the interaction method between an external object and a touch display device can be embodied as computer-readable instructions through program design, and thus stored in a computer-readable storage medium. When such a computer-readable storage medium is read or accessed by a computing device or a computer, the computer-readable instructions therein are executed by a processor in the computing device or the computer to implement the interaction method between an external object and a touch display device.

A further embodiment of the application provides a touch display device, comprising a touch sensor and a touch processor, the touch processor is configured to execute the method described in the foregoing embodiments of the interaction method between an external object and a touch display device.

Yet another embodiment of the application provides a touch system, comprising the touch display device according to the above embodiment and an active object, the active object is configured to send a downlink signal to the touch display device in response to receiving the uplink signal, and the downlink signal includes the communication signal and the touch signal of the active object, the active object includes an active pen.

Although the present application has been described in conjunction with some embodiments, it is not intended to be limited to the specific embodiments set forth herein. Instead, the scope of the present application is defined only by the appended claims. Additionally, although individual features may be included in different claims, these may possibly be advantageously combined, and inclusion in different claims does not imply that the combination of features is not feasible and/or advantageous. The order of features in the claims does not imply any specific order in which the features must work.

1. A interaction method between an external object and a touch display device, the touch display device comprising a touch sensor, wherein the method comprises:
an image refresh cycle of the touch display device comprising a plurality of display driving periods and a plurality of non-display driving periods, the display driving periods alternating with the non-display driving periods, the plurality of non-display driving periods including a plurality of first touch periods and a plurality of second touch periods, each of the first touch periods or each of the second touch periods being one non-display driving period of the plurality of non-display driving periods, and the image refresh cycle including at least two second touch periods of the plurality of second touch periods between two adjacent first touch periods; and
the external object comprising at least one of an active object and a passive object, the touch display device receiving a communication signal from the active object, sensing a touch signal of the passive object via the touch sensor during the plurality of first touch periods to detect a touch of the passive object on the touch display device, and sensing a touch signal of the active object via the touch sensor during the plurality of second touch periods to detect a touch of the active object on the touch display device.

2. The interaction method according to claim 1, wherein there exists at least one second touch period of the plurality of second touch periods between every two adjacent first touch periods of the plurality of first touch periods in the image refresh cycle.

3. (canceled)

4. The interaction method according to claim 1, wherein the image refresh cycle comprises four second touch periods and four first touch periods, and there exists one second touch period of the four second touch periods between every two adjacent first touch periods of the four first touch periods.

5. The interaction method according to claim 1, wherein the detecting the touch of the passive object on the touch display device and the detecting the touch of the active object on the touch display device comprise collecting the touch signal of the passive object sensed by the touch sensor and collecting the touch signal of the active object sensed by the touch sensor, respectively, wherein the plurality of non-display driving periods further comprise a noise processing period, and the method further comprises:
during the noise processing period, acquiring a signal-to-noise ratio of at least one of the touch signal of the active object or the touch signal of the passive object; and
in response to the signal-to-noise ratio being lower than a threshold, adjusting a frequency of collecting the touch signal of the active object or the touch signal of the passive object.

6. The interaction method according to claim 1, wherein each first touch period of the plurality of first touch periods and each second touch period of the plurality of second touch periods have a same time length, and the time length does not exceed 180 microseconds.

7. The interaction method according to claim 6, wherein the plurality of non-display driving periods in the image refresh cycle further comprise a noise processing period, and sums of numbers of the first touch periods and the second touch periods on two sides of the noise processing period are equal to each other.

8. The interaction method according to claim 1, wherein the method further comprises:
in response to the touch display device not receiving the communication signal from the active object, sensing the touch signal of the passive object via the touch sensor during the plurality of second touch periods to detect a touch of the passive object on the touch display device.

9. The interaction method according to claim 8, wherein the method further comprises:
in response to the touch display device not receiving the communication signal from the active object, the touch display device not detecting the touch of the active object or the passive object on the touch display device during the plurality of first touch periods.

10. The interaction method according to claim 1, wherein the method further comprises:
in response to the touch display device not receiving the communication signal from the active object, sensing the touch signal of the passive object via the touch sensor during the plurality of second touch periods and the plurality of first touch periods to detect the touch of the passive object on the touch display device.

11. The interaction method according to claim 1, wherein the image refresh cycle comprises six second touch periods and four first touch periods, and there exist two second touch periods between every two adjacent first touch periods of the four first touch periods.

12. The interaction method according to claim 1, wherein the image refresh cycle comprises five second touch periods and four first touch periods, and there exists one second touch period of the five second touch periods between every two adjacent first touch periods of the four first touch periods.

13. The interaction method according to claim 1, further comprising:
the touch display device sending an uplink signal to the external object, and periodically sending the uplink signal to the external object by taking the image refresh cycle of the touch display device as a transmission period, the uplink signal comprising seven bits of data.

14. The interaction method according to claim 13, wherein the uplink signal is encoded with direct sequence spread spectrum, and each bit of data of the uplink signal is encoded as a P-bit spread spectrum code sequence, where P is a positive integer.

15. The interaction method according to claim 14, wherein each bit of data is encoded as a 31-bit spread spectrum code sequence.

16. The interaction method according to claim 1, wherein the touch signal of the active object comprises pressure information for indicating a touch pressure of the active object on the touch display device, and the pressure information comprises a multi-bit pressure information code, wherein the sensing the touch signal of the active object via the touch sensor during the plurality of second touch periods to detect the touch of the active object on the touch display device comprises:
receiving different bits of pressure information code in the multi-bit pressure information code via the touch sensor during different second touch periods of the plurality of second touch periods respectively.

17. (canceled)

18. The interaction method according to claim 1, wherein the active object comprises a power source, the touch signal of the active object comprises power information for indicating a state of the power source, and the power information comprises a multi-bit power information code, wherein the sensing the touch signal of the active object via the touch sensor during the plurality of second touch periods to detect the touch of the active object on the touch display device comprises:
receiving different bits of power information code in the multi-bit power information code via the touch sensor during different second touch periods of the plurality of second touch periods respectively.

19. (canceled)

20. The interaction method according to claim 1, wherein the active object comprises a plurality of keys, the touch signal of the active object comprises key information for indicating states of the plurality of keys, and the key information comprises a multi-bit key information code corresponding to the plurality of keys, wherein the sensing the touch signal of the active object via the touch sensor during the plurality of second touch periods to detect the touch of the active object on the touch display device comprises:
receiving different bits of key information code in the multi-bit key information code via the touch sensor during different second touch periods of the plurality of second touch periods respectively.

21. The interaction method according to claim 1, wherein the touch signal of the active object comprises hovering information for indicating that the active object is in a hovering state, and identification information for indicating an identification of the active object, the hovering information comprises a hovering information code, and the identification information comprises an identification information code, wherein the sensing the touch signal of the active object via the touch sensor during the plurality of second touch periods to detect the touch of the active object on the touch display device comprises:
receiving the hovering information code and the identification information code via the touch sensor during different second touch periods of the plurality of second touch periods, respectively.

22. The interaction method according to claim 1, wherein the touch signal of the active object comprises a multi-bit touch signal code, and the multi-bit touch signal code comprises at least one selected from a group consisting of a multi-bit pressure information code, a multi-bit power information code, a multi-bit key information code, a hovering information code, an identification information code, and a check bit code,
wherein the sensing the touch signal of the active object via the touch sensor during the plurality of second touch periods to detect the touch of the active object on the touch display device comprises:
receiving three to six bits of touch signal code in the multi-bit touch signal code via the touch sensor during each of the plurality of second touch periods.

23. The interaction method according to claim 22, wherein each bit of touch signal code in the three to six bits of touch signal code comprises a multi-bit pulse sequence, and multi-bit pulse sequences of different bits of touch signal code in the three to six bits of touch signal code have different phases.

24. (canceled)

25. A computer-readable storage medium comprising computer-executable instructions, when the computer-executable instructions are executed, the interaction method according to claim 1 is implemented.

26. A touch display device, comprising a touch sensor and a touch processor,
wherein the touch processor is configured to perform the interaction method according to claim 1.

27. A touch system, comprising the touch display device according to claim 26 and an active object,
wherein the active object is configured to send a downlink signal to the touch display device in response to receiving an uplink signal, and the downlink signal comprises the communication signal and the touch signal of the active object, wherein the active object comprises an active pen.
